(19) United States
(12) Patent Application Publication
(10) Pub. No.: US 2015/0005156 A1
(43) Pub. Date: Jan. 1, 2015

(54) Processes for the Preparation of Silicon Containing Intermetallic Compounds and Intermetallic Compounds Prepared Thereby

(71) Applicant: Dow Corning Corporation, Midland, MI (US)

(72) Inventors: Aswini Dash, Midland, MI (US); Dimitris Katsoulis, Midland, MI (US)

(73) Assignee: Dow Corning Corporation, Midland, MI (US)

(21) Appl. No.: 14/381,996

(22) PCT Filed: Mar. 7, 2013
(86) PCT No.: PCT/US13/29541

§ 371 Date: Aug. 29, 2014

Related U.S. Application Data
(60) Provisional application No. 61/624,421, filed on Apr. 16, 2012.

(51) Int. Cl. B01J 27/13; B01J 27/128; B01J 27/10

(52) U.S. Cl. CPC B01J 27/13; B01J 27/10; B01J 27/128
USPC 502/225; 502/229; 502/230; 502/224

(57) ABSTRACT

Intermetallic compounds, such as metal silicides, e.g., PdSi and/or Pd₂Si, can be selectively prepared in a two step process including the steps of (1) vacuum impregnating silicon with a metal halide, and (2) ball milling the product of step (1).

### TECHNICAL FIELD

A process selectively produces intermetallic compounds, such as palladium silicides and intermetallic compounds of Cu, Pd, and Si. The resulting intermetallic compounds can be used as catalysts for preparing organofunctional halosilanes.

### BACKGROUND

Methods for preparing organohalosilanes may include combining an organohalide with a contact mass to form the organohalosilane, where the contact mass includes a metal silicide. WO2011/094140 mentions a method of preparing organohalosilanes comprising combining an organohalide having the formula RX (I), wherein R is a hydrocarbyl group having 1 to 10 carbon atoms and X is fluoro, chloro, bromo, or iodo, with a contact mass comprising at least 2% of a palladium silicide of the formula PdₓSi_{y} (II), wherein x is an integer from 1 to 5 and y is 1 to 8, or a platinum silicide of formula Pt_{z}Si (III), wherein z is 1 or 2, in a reactor at a temperature from 250 to 700° C. to form an organohalosilane.

### BRIEF SUMMARY OF THE INVENTION

A process for preparing an intermetallic compound comprises:

(1) vacuum impregnating a metal halide on silicon, thereby producing a mixture, and
(2) mechanochemically processing the mixture under an inert atmosphere, thereby producing a reaction product comprising the intermetallic compound. The intermetallic compound comprises silicon and at least one metal other than Si.

### DETAILED DESCRIPTION OF THE INVENTION

The Brief Summary of the Invention and the Abstract of the Disclosure are hereby incorporated by reference. All ratios, percentages, and other amounts are by weight, unless otherwise indicated. The articles “a”, “an”, and “the” each refer to one or more, unless otherwise indicated by the context of the specification. Abbreviations used herein are defined in Table 1, below.

TABLE 1
Abbreviations

| Abbreviation | Word |
|---|---|
| % | percent |
| ° C. | degrees Celsius |
| EDS | energy dispersive spectroscopy |
| g | gram |
| h | hour |
| ICP | inductively coupled plasma |
| kPa | kiloPascals |
| mL | milliliters |
| RT | room temperature of 23° C. |
| sccm | standard cubic centimeters per minute |
| SEM | scanning electron microscopy |
| μm | micrometers |
| XRD | x-ray diffraction |

The disclosure of ranges includes the range itself and also anything subsumed therein, as well as endpoints. For example, disclosure of a range of 2.0 to 4.0 includes not only the range of 2.0 to 4.0, but also 2.1, 2.3, 3.4, 3.5, and 4.0 individually, as well as any other number subsumed in the range. Furthermore, disclosure of a range of, for example, 2.0 to 4.0 includes the subsets of, for example, 2.1 to 3.5, 2.3 to 3.4, 2.6 to 3.7, and 3.8 to 4.0, as well as any other subset subsumed in the range. Similarly, the disclosure of Markush groups includes the entire group and also any individual members and subgroups subsumed therein. For example, disclosure of the Markush group, Br, Cl, F, and I includes the member Br individually; the subgroup Cl and I; and any other individual member and subgroup subsumed therein.

“Mechanochemical processing” means applying mechanical energy to initiate chemical reactions and/or structural changes, (i.e., where the structural changes may refer to changes in physical shape and/or changes from a crystalline form to an amorphous form or a change from one crystalline form to a different crystalline form). Mechanochemical processing may be performed, for example, by techniques such as milling, e.g., ball milling. Mechanochemical processing may be performed, for example, using the methods and equipment described in, “Mechanical alloying and milling” by C. Suryanarayana, Progress in Materials Science 46 (2000) 1-184.

### Process for Making Intermetallic Compounds

A process comprises:

(1) vacuum impregnating a metal halide on Si particles, where the metal halide has formula MX_{q}, where each M is independently a metal atom selected from the group consisting of Ag, Au, Co, Cr, Cu, Fe, Hf, Ir, Mn, Mo, Nb, Ni, Os, Pd, Pt, Re, Rh, Ru, Ta, Ti, V, W, and Zr; each X is independently a halogen atom; and q has a value matching valence of the metal atom selected for M, thereby producing a mixture comprising M_{z}Si_{w}X_{zq}, where z represents the molar amount of M and w represents the molar amount of Si and zq represents a relative molar amount of the halogen atoms in the mixture; and

(2) mechanochemically processing of the mixture prepared in step (1) under an inert atmosphere, thereby producing a redox reaction product comprising
(i) an intermetallic compound of formula M_{z}Si_{(w-y/4)}X_{(zq-y)}, where y/4 represents a molar amount of Si removed from the mixture during step 2 and y represents a molar amount of halogen atom removed from the mixture during step (2), and y/4<w and y<zq.

Step (1) of the process involves vacuum impregnation of a metal halide on silicon (Si) particles. Vacuum impregnation results in a physical mixture according to the following formula: zMX_{q}+wSi→M_{z}Si_{w}X_{zq}, where subscript z represents the molar amount of metal atoms present in the mixture and subscript w represents the molar amount of silicon atoms present in the mixture. In these formulas, the subscripts may have the following values: 0<z<1, 0<w<1, and a quantity (z+w)=1.

The metal atom in the metal halide of formula MX_{q} may be selected from the group consisting of Ag, Au, Co, Cr, Cu, Fe, Hf, Ir, Mn, Mo, Nb, Ni, Os, Pd, Pt, Re, Rh, Ru, Ta, Ti, V, W, and Zr. Alternatively, M may be selected from the group consisting of Ag, Au, Cu, Ni, Pd, and Pt. Alternatively, M may be selected from the group consisting of Cu, Pd, and Pt. Alternatively, M may be Pd. Each X independently may be selected from the group consisting of Br, Cl, F, and I. Alternatively, X may be Br, Cl, or F. Alternatively, X may be Cl or F. Alternatively, each X may be Cl. Alternatively, the metal halide comprises a palladium halide of formula PdX₂, where each X is independently a halogen atom, as described above.

To perform step (1), the metal halide may be dissolved in a solvent, such as water or other polar protic solvent capable of dissolving the metal halide to form a solution comprising the metal halide and the solvent. The selection of solvent will vary depending on factors such as the solubility of the metal halide chosen in the solvent, however, the solvent may comprise a primary alcohol such as methanol or ethanol in addition to, or instead of, the water. The amount of solvent used is sufficient to dissolve the metal halide. The exact amount depends on various factors including the metal halide selected and the solubility of the metal halide in solvent, however, the amount may range from 0.1% to 99.9%, alternatively 1% to 95%, based on the combined weight of metal halide and solvent. One single metal halide may be used in the solution. Alternatively, two or more metal halides, as described above, may be used in the solution.

One or more additional ingredients, such as an acid, an additional metal halide, or both, may optionally be added in the solution. The acid may be, for example, HCl. The amount of HCl may range from 0.1% to 1.0% based on the total weight of the solution.

The additional metal halide may be a copper halide such as a copper halide of formula CuX, a copper halide of formula CuX₂, or a combination thereof, where X is as described above. The copper halide may be added in an amount ranging from 0.01% to 0.99% based on total weight of metal halide used.

The silicon may have any convenient solid form, such as particulate. Ground silicon powder may be combined with the solution described above to form a slurry. Ground silicon powder with a particle size of less than 100 pm may be used. Ground silicon powder may have a purity >99.9%, alternatively >95%, and alternatively >90%. Ground silicon powder is commercially available from sources such as Sigma-Aldrich, Inc. of St. Louis, Mo., U.S.A. The amount of ground silicon powder may range from 0.01% to 0.99% based on the total weight of the metal halide.

Vacuum impregnation of the metal halide on the silicon may be performed by any convenient means, such as pulling vacuum on a container containing the slurry. Pressure for vacuum impregnation is below atmospheric pressure (vacuum sufficient enough for the metal halide solution to diffuse into, or interact with sites on, the surfaces of the Si particles). Pressure may be less than 102 kPa, alternatively 3.5 kPa to less than 102 kPa, alternatively 0.01 kPa to 4 kPa. Time for vacuum impregnation depends on various factors including the pressure chosen and the desired intermetallic product.

The slurry may be dried to form a powder. Drying may be performed by any convenient means, such as heating at atmospheric pressure or under vacuum. Drying may be performed at RT or with heating. Drying may be performed after step (1), concurrently with vacuum impregnation during step (1), or both. Time for drying depends on various factors including the solvent and amount of solvent selected, the pressure selected for vacuum impregnation, and how much solvent is removed during vacuum impregnation. However, drying may be performed by heating the slurry at 50° C. to 170° C., alternatively 100° C. to 140° C., for 1 h to 3 h, alternatively 1 h to 12 h, and alternatively 1 h to 24 h.

Step (2) of the method described above comprises mechanochemical processing of the mixture prepared in step (1). Step (2) involves a redox reaction of the components in the mixture according to the following formulas.

$$\begin{matrix}{M}_{z} {Si}_{w} {X}_{zq} \\ Mixture\end{matrix} \begin{matrix}( + Energy ) \\ \end{matrix} \begin{matrix}\to \\ \end{matrix} \begin{matrix}{M}_{z} {Si}_{( w - y / 4 )} {X}_{( zq - y )} \\ Intermetallic product\end{matrix} \begin{matrix}+ \\ \end{matrix} \begin{matrix}y / 4 {SiX}_{4} \\ By \text{-} Product\end{matrix}$$

During mechanochemical processing a chemical reaction occurs, which is a redox reaction. Part of the silicon is oxidized to form volatile SiX₄ [when X=Cl or F] and part of the Si remains with the metal and remaining halide. When X =Br or I, the by-product SiX₄ can be removed by using an appropriate solvent. So, the combined amounts of M and Si in the intermetallic product change from a quantity (z+w) in the mixture formed in step (1) to (z+(w−y/4)), which is less than the quantity (z+w) by y/4, in the intermetallic product produced by step (2). The amount for y can be a proportion of the starting amount of halide. The starting amount of halide is zq. In this reaction y<zq. Alternatively, the combined amounts of M and Si in the intermetallic product change from (z+w)=1 in the mixture formed in step (1) to (z+(w−y/4)), which is less than the quantity 1 by y/4, in the intermetallic product produced by step (2).

Mechanochemical processing may be performed as described above. Mechanochemical processing parameters such as temperature, time, type of mill and type of balls used are selected to react the metal halide and the Si in the mixture. In conventional laboratory equipment the temperature for mechanochemical processing may range from RT to 40° C. Conventional equipment and techniques may be used, for example, ball milling may be performed in a stainless steel container by adding the product of step (1) and metal balls, such as stainless steel or tungsten balls, and milling for a time ranging from 0.15 h to 24 h, alternatively 0.15 h to 1 h, alternatively 2 h to 8 h, and alternatively 1 h to 24 h. Weight ratio of steel balls to powdered mixture obtained from step (1) may range from 5 to 50, alternatively 5 to 20, alternatively 10 to 15, and alternatively 30 to 50. The amount and size of the balls used for ball milling depends on various factors including the amount of mixture and the size of the container in which ball milling is performed, however, the balls may have a diameter ranging from 6 mm to 12 mm, alternatively 6.5 mm to 9.5 mm, and alternatively 9.5 mm to 12 mm.

The method described above may optionally comprise one or more additional steps. For example, the method may further comprise the step of activating the silicon before step (1). Activating the silicon may be performed, for example, by dissolving an ionic metal salt compound, such as CsF in a solvent, combining the resulting solution with the silicon as described above, and vacuum impregnating under conditions as described above for step (1). Alternatively, the ionic metal salt may be selected from the group consisting of KF, KCl, LiF, and KOH. The resulting activated silicon may optionally be dried as described above, and then used as a starting material in step (1). The method may optionally further comprise step (3), removing all or a portion of the by-product. The SiX₄ by-product is volatile [when X=Cl or F] and may be removed from the intermetallic compound through heating or by exposure to a stream of air or inert gas such as nitrogen. When X=Br or I then the SiX₄ by-product may be removed from the intermetallic compound with common separation techniques such using the appropriate solvent.

The product prepared by the method described above is a redox reaction product. The product comprises an intermetallic compound and a by-product comprising a silicon tetrahalide of formula SiX₄, where X is as described above. The intermetallic compound may have formula M_{z}Si_{(w-y/4)}X_{(zd-y)}, where y represents a molar amount of halogen atom removed from the mixture during step (2), and y<zq. After step (2), the molar amounts of Si and X in the intermetallic compound are less than the molar amounts of Si and X present in the mixture in step (1); i.e., a quantity (zq−y)<zq because some of the silicon and halide form the by-product SiX₄. Alternatively, the quantity (z+(w−y/4)) may have a value <1.

The intermetallic compound may comprise a metal silicide. Alternatively, the intermetallic compound may comprise a species selected from the group consisting of PdSi; Pd₂Si; Pd_{z}Si_{(w-y/4)}X_{(zq-y)}, where 0.01 zq<y<0.99zq. Alternatively, the intermetallic compound may have more than one metal. For example, the intermetallic compound may comprise CuₙPdₘSi_{(w-y/4)}X_{(zd-y)}; where n represents the molar amount of Cu, m represents the molar amount of Pd and 0.01 zq<y<0.99zq. Alternatively, a quantity (m+n) may have a value equal to z; the quantity (z+w) may have a value <1, subscript z may have a value 0<z<1, and subscript w may have a value 0<w<1.

The intermetallic compound prepared by the process described above is useful for making organohalosilanes. The intermetallic compound, such as the palladium silicide, prepared in the process described above may be used as component (II) in the method for making an organohalosilane mentioned in, for example, WO2011/094140. WO2011/094140 mentions a method of preparing organohalosilanes, where the method comprises combining an organohalide with a contact mass comprising at least 2% (w/w) of a palladium silicide of the formula Pd_{b}Si_{c} (II), wherein b is an integer from 1 to 5 and c is 1 to 8, or a platinum silicide of formula Pt_{d}Si (III), wherein d is 1 or 2, in a reactor at a temperature from 250 to 700° C. to form an organohalosilane.

### EXAMPLES

These examples are intended to illustrate some embodiments of the invention and should not be interpreted as limiting the scope of the invention set forth in the claims.

### Example A—Sample Preparation and Analysis

An amount of metal chloride was dissolved in 0.3 mL distilled water. Ground silicon powder with particle size less than 100 μm was added, and the resulting composition was vacuum impregnated for 1 h at room temperature of 23° C. and pressure of 4 kPa to form a slurry.

The slurry was dried at 120° C. for 2 h, and a fine black powder was obtained. The powder was ball milled using a SPEX 8000 mixer/mill in a stainless steel container with 12 mm diameter stainless steel balls under a nitrogen atmosphere. After ball milling, the resulting solid was retrieved and analyzed by XRD and SEM/EDS.

### Examples 1-13

Samples were prepared and analyzed according to the method of Example A. The metal chloride selected, the amounts of metal chloride and ground silicon, the molar ratio of silicon to metal chloride, the amount of powder ball milled, the time the powder was ball milled, and the weight ratio of steel balls to powder are shown below in Table 2, and the results are in Table 3.

TABLE 2
Experimental Conditions for Examples 1-13

| | | | | Molar ratio | Amt. of | Time for | |
|---|---|---|---|---|---|---|---|
| | | Metal | Ground | of Silicon | Powder | Ball | Weight Ratio of |
| | Metal | Chloride | Si Amt. | to Metal | added to | Milling | Steel Balls and |
| Ex. | Chloride | Amt. (g) | (g) | Chloride | Ball Mill (g) | (h) | Powder |
| 1 | PdCl₂ | 0.61 | 0.61 | 6.3 | 0.45 | 2 | 15 |
| 2 | PdCl₂ | 0.61 | 0.61 | 6.3 | 0.45 | 8 | 15 |
| 3 | PdCl₂ | 0.47 | 0.075 | 1.0 | 0.55 | 8 | 13 |
| 4 | PdCl₂ | 0.47 | 0.15 | 2.0 | 0.62 | 8 | 11 |
| 5 | PdCl₂ | 0.47 | 0.11 | 1.5 | 0.58 | 8 | 12 |
| 6 | CuCl₂ | 0.61 | 0.61 | 4.8 | 0.5 | 2 | 14 |
| 7 | CuCl₂ | 0.61 | 0.61 | 4.8 | 0.5 | 8 | 14 |
| 8 | NiCl₂ | 0.61 | 0.61 | 4.6 | 0.45 | 2 | 15 |
| 9 | NiCl₂ | 0.61 | 0.61 | 4.6 | 0.45 | 8 | 15 |
| 10 | AuCl₃ | 0.5 | 0.5 | 10.8 | 0.4 | 2 | 11 |
| 11 | AuCl₃ | 0.5 | 0.5 | 10.8 | 0.4 | 8 | 11 |
| 12 | H₂PtCl₆ | 0.6 | 0.6 | 14.6 | 0.8 | 2 | 9 |
| 13 | H₂PtCl₆ | 0.6 | 0.6 | 14.6 | 0.8 | 8 | 9 |

TABLE 3
Results of Experiments in Table 2

| Example | Results |
|---|---|
| 1 | Analytical data suggested loss of chloride, and based on EDS elemental |
| | mapping, the sample showed a composition containing Pd_{2.7}Si_{17.2}Cl_{2.4} with a |
| | stoichiometry corresponding to Pd₁Si_{6.37}Cl_{0.88}. This corresponded to an |
| | estimate of 53.2 mol % Si loss and 61.4 mol % chloride loss. XRD data |
| | suggested the sample contained crystalline phase Pd₂Si (52 mol %) and PdSi |
| | (21 mol %) as well as the presence of Si and Pd (balance). |
| 2 | Analytical data suggested loss of chloride, and based on EDS elemental |
| | mapping, the sample showed a composition containing Pd_{6.9}Si_{39.8}Cl_{1.9} with a |
| | stoichiometry corresponding to Pd₁Si_{5.7}Cl_{0.27}. This corresponded to an |
| | estimate of 57.6 mol % Si loss and 88 mol % chloride loss. XRD data suggested |
| | the sample contained crystalline phase Pd₂Si (23 mol %) and PdSi (47 mol %) as |
| | well as the presence of Si (balance). |
| 3 | Analytical data suggested loss of chloride, and based on EDS elemental |
| | mapping, the sample showed a composition containing Pd_{32.1}Si_{21.5}Cl_{4.0} with |
| | a stoichiometry corresponding to Pd₁Si_{0.67}Cl_{0.12}. XRD data suggested the |
| | sample contained crystalline phase Pd₂Si (>90 mol %) and Pd (balance) with no |
| | silicon left behind. |
| 4 | Analytical data suggested loss of chloride, and based on EDS elemental |
| | mapping, the sample showed a composition containing Pd₂₇Si_{31.2}Cl_{2.1} with a |
| | stoichiometry corresponding to Pd₁Si_{1.15}Cl_{0.08}. XRD data suggested the |
| | sample contained crystalline phase Pd₂Si (65 mol %), and PdSi (31 mol %) as |
| | well as presence of silicon (balance) with no palladium left behind. |
| 5 | Analytical data suggested loss of chloride, and based on EDS elemental |
| | mapping, the sample showed a composition containing Pd₂₁Si_{26.2}Cl_{3.1} with a |
| | stoichiometry corresponding to Pd₁Si_{1.25}Cl_{0.148}. XRD data suggested the |
| | sample contained crystalline phase PdSi (93 mol %), and Pd₂Si (7 mol %) with no |
| | silicon and palladium left behind. |
| 6 | Analytical data suggested loss of chloride and based on EDS elemental |
| | mapping, the sample showed a composition containing Cu_{10.6}Si_{45.8}Cl_{9.9} with |
| | a stoichiometry corresponding to Cu₁Si_{4.32}Cl_{0.93}. XRD data suggested the |
| | solid composition contained crystalline phase Si, Cu, CuCl₂(H₂O)₂ and in some |
| | instances FeCl₂(H₂O)₂ and FeSi₂, but no evidence of crystalline phase copper- |
| | silicon alloys/silicides were observed. |
| 7 | Analytical data suggested loss of chloride, and based on EDS elemental |
| | mapping, the sample showed a composition containing Cu_{7.8}Si_{33.2}Cl_{0.8} with a |
| | stoichiometry corresponding to Cu₁Si_{4.26}Cl_{0.1}. XRD data suggested the solid |
| | composition contained crystalline phase Si, Cu, CuCl₂(H₂O)₂ and in some |
| | instances FeCl₂(H₂O)₂ and FeSi₂, but no evidence of crystalline phase copper- |
| | silicon alloys/silicides were observed. |
| 8 | Analytical data suggested loss of chloride, and based on EDS elemental |
| | mapping, the sample showed a composition containing Ni_{3.3}Si_{16.3}Cl_{7.1} with a |
| | stoichiometry corresponding to Ni₁Si_{4.94}Cl_{2.15}. XRD data suggested the solid |
| | composition contained crystalline phase Si, NiCl₂(H₂O)₂, and Ni with very |
| | broad peaks but no evidence of crystalline phase nickel-silicon alloys/silicides. |
| 9 | Analytical data suggested loss of chloride, and based on EDS elemental |
| | mapping, the sample showed a composition containing Ni_{5.1}Si_{24.4}Cl_{8.8} with a |
| | stoichiometry corresponding to Ni₁Si_{4.78}Cl_{1.72}. XRD data suggested the solid |
| | composition contained crystalline phase Si, NiCl₂(H₂O)₂, and Ni with very |
| | broad peaks but no evidence of crystalline phase nickel-silicon alloys/silicides. |
| 10 | Analytical data suggested loss of chloride, and based on EDS elemental |
| | mapping, the sample showed a composition containing Au_{2.96}Si_{34.92}Cl_{21.26} |
| | with a stoichiometry corresponding to Au₁Si_{11.8}Cl_{7.18}. XRD data suggested |
| | the solid composition contained crystalline phase Si (12 mol %), Au (24 mol %), |
| | and a large amount of amorphous materials (64 mol %), but no evidence of |
| | crystalline phase gold-silicon alloys/silicides. |
| 11 | Analytical data suggested loss of chloride, and based on EDS elemental |
| | mapping, the sample showed a composition containing Au_{3.76}Si_{49.9}Cl_{1.36} |
| | with a stoichiometry corresponding to Au₁Si_{13.27}Cl_{0.36}. XRD data suggested |
| | the solid composition contained crystalline phase Si (2 mol %), Au (11 mol %), |
| | FeSi₂(14 mol %) and a large amount of amorphous materials (73 mol %), but no |
| | evidence of crystalline phase gold-silicon alloys/silicides. |
| 12 | Analytical data suggested loss of chloride, and based on EDS elemental |
| | mapping, the sample showed a composition containing Pt_{2.72}Si_{50.88}Cl_{6.63} |
| | with a stoichiometry corresponding to Pt₁Si_{18.7}Cl_{2.44}. XRD data suggested the |
| | solid composition contained crystalline phase Si, Pt, FeCl₂(H₂O)₄, quartz and |
| | some iron silicides, but no evidence of crystalline phase platinum-silicon |
| | alloys/silicides. |
| 13 | Analytical data suggested loss of chloride, and based on EDS elemental |
| | mapping, the sample showed a composition containing Pt_{2.37}Si_{47.98}Cl_{2.26} |
| | with a stoichiometry corresponding to Pt₁Si_{20.24}Cl_{0.95}. XRD data suggested |
| | the solid composition contained crystalline phase Si, Pt, FeCl₂(H₂O)₄, quartz |
| | and some iron silicides, but no evidence of crystalline phase platinum-silicon |
| | alloys/silicides. |

### Example 14

A sample was prepared according to the method of Example A. After the ball milling process was complete, the lid on the steel vial containing the sample was opened and a piece of pH paper shown into it turned red. ICP analysis on the solid retrieved showed loss of chloride (92 mol %) and loss of Si (42 mol %) as volatile species (SiCl₄). Based on the elemental analyses, the solid composition had a stoichiometry corresponding to Pd₁Si_{0.67}C_{0.136}. XRD results indicated that Pd₂Si formed.

TABLE 4
Example 14 conditions

| | | | | Molar ratio | Amt. of | Time for | |
|---|---|---|---|---|---|---|---|
| | | Metal | Ground | of Silicon | Powder | Ball | Weight Ratio of |
| | Metal | Chloride | Si Amt. | to Metal | added to | Milling | Steel Balls and |
| Ex. | Chloride | Amt. (g) | (g) | Chloride | Ball Mill (g) | (h) | Powder |
| 14 | PdCl₂ | 0.8 | 0.13 | 1.0 | 0.6 | 8 | 12 |

### Example B—Two Step Sample Preparation and Analysis

An amount of CsF (0.3 g) was dissolved in 0.3 mL distilled water; and 0.57 g of ground silicon powder with particle size less than 100 μm was added. The resulting composition was vacuum impregnated for 1 h at room temperature of 23° C. and pressure of 4 kPa to form a slurry mixture. The slurry mixture was dried at 120° C. for 2 h, and an activated silicon was obtained.

PdCl₂ and CuCl₂ were dissolved in 0.3 mL of distilled water, and the resulting solution was added to 0.9 g of the activated silicon. The resulting mixture was vacuum impregnated for 1 h at room temperature of 23° C. and pressure of 4 kPa and subsequently dried at 120° C. for 2 h.

The resulting powder was ball milled using a SPEX 8000 mixer/mill in a stainless steel container with 12 mm diameter stainless steel balls under a nitrogen atmosphere. After ball milling, the resulting solid mixture was retrieved and analyzed by XRD and SEM/EDS.

### Examples 15 and 16

Samples were prepared according to the method of Example B. The amounts of PdCl₂ and CuCl₂, the amount of powder ball milled, the time the powder was ball milled, and the weight ratio of steel balls to powder, and the results are shown below in Table 5.

TABLE 5
Conditions and Results for Examples 15 and 16

| | | | Amt. of | | Wt. Ratio | |
|---|---|---|---|---|---|---|
| | PdCl₂ | CuCl₂ | Powder | Time for | of Steel | |
| | Amt. | Amt. | added to Ball | Ball | Balls and | Composition of the Solid |
| Ex. | (g) | (g) | Mill (g) | Milling (h) | Powder | Mixture Retrieved |
| 15 | 0.5 | 0.1 | 0.5 | 2 | 14 | Cu_{0.18}Pd_{1.82}Si |
| | | | | | | (42 mol %), CsCl (8 mol %) |
| | | | | | | and Si (51 mol %). |
| 16 | 0.5 | 0.1 | 0.5 | 8 | 14 | Cu_{0.18}Pd_{1.82}Si |
| | | | | | | (31 mol %), PdSi (8 mol %), |
| | | | | | | CsCl (18 mol %) and Si |
| | | | | | | (42 mol %). |

### Example 17—Chlorosilane Production

An intermetallic compound was prepared using a method as described above in example 5, and 0.5 g was loaded into a quartz tube flow through reactor. The reactor was initially purged with argon for 1 h. The sample was treated with H₂ (20 sccm) at 500° C. for 2 h and subsequently the reactor temperature was reduced to 300° C. H₂ flow was stopped followed by purging with argon. Next, MeCl (1 sccm) was flowed through the sample bed, and the evolution of volatiles were analyzed by combination of GC and GC-MS. At 300° C., high selectivity towards Me₂SiCl₂ (76 mol %) was observed, with the rest as MeSiCl₃ (24 mol %). As the reaction continued, the selectivity of the reaction for producing Me₂SiCl₂ dropped and a 1:1 ratio of Me₂SiCl₂/MeSiCl₃ was observed at 350° C. after 1 h. Continuing the reaction at 400° C. for 1 h lead to significant drop in Me₂SiCl₂ selectivity and product composition contained Me₂SiCl₂ (10 mol %), MeSiCl₃ (77 mol %) and SiCl₄ (13 mol %).

### Example 18—Chlorosilane Production

An intermetallic compound was prepared by the method as described above in example 16, and 0.5 g was loaded into a quartz tube flow through reactor. The reactor was initially purged with argon for 1 h. The sample was treated with H₂ (20 sccm) at 500° C. for 2 h and subsequently the reactor temperature was reduced to 300° C. Hydrogen flow was stopped, followed by purging with argon. Next, MeCl (1 sccm) was flown through the sample bed and the evolution of volatiles were analyzed by combination of GC and GC-MS. At 300° C., Me₂SiCl₂ (83 mol %) was observed along with MeSiCl₃ (11 mol %) and Me₃SiCl (6 mol %). As the reaction continued at 300° C., the selectivity of the reaction for producing Me₂SiCl₂ dropped, and after 1 h, it decreased to 13 mol % Me₂SiCl₂ and the rest as MeSiCl₃ (82 mol %) and SiCl₄ (5 mol %). At 350° C. and higher, Me₂SiCl₂ production stopped. At 400° C., the product composition contained MeSiCl₃ (83 mol %) and SiCl₄ (17 mol %).

### Comparative Examples C1-C5—Omit Ball Milling Step

Samples of the fine black powders obtained by drying the slurry mixtures prepared in examples 1, 6, 8, 10 and 12 were analyzed by XRD and SEM/EDS before ball milling. In each comparative example, analytical data suggested the presence of Si and metal chloride, indicating binary silicide did not form. For the slurry from example 1, which produced PdCl₂/Si sample (C1), EDS elemental mapping on the sample showed a composition containing Pd_{4.9}Si_{66.7}Cl_{11.2}, with a stoichiometry corresponding to Pd₁Si_{13.8} Cl_{2.28}. For the slurry from example 6, which produced CuCl₂/Si sample (C2), EDS elemental mapping on the sample showed a composition corresponding to Cu_{5.4}Si_{47.8}Cl_{6.9}, with a stoichiometry corresponding to Cu₁Si_{8.81} C_{1.28}. For the slurry from example 8, which produced NiCl₂/Si sample (C3), EDS elemental mapping on the sample showed a composition containing Ni_{2.6}Si_{28.6}Cl_{5.7}, with a stoichiometry corresponding to Ni₁Si₁₁Cl_{2.19}. For the slurry from example 10, which produced AuCl₃/Si sample (C4), EDS elemental mapping on the sample showed a composition containing Au_{2.67}Si_{60.87}Cl_{0.17}, with a stoichiometry corresponding to AuSi_{22.76}Cl_{0.44}. For the slurry from example 12, which produced H₂PtCl₆/Si sample (C5), EDS elemental mapping on the sample showed a composition containing Pt_{6.42}Si_{56.45}Cl_{37.07}, with a stoichiometry corresponding to Pt₁Si_{8.79}Cl_{5.77}.

### Comparative Example C6—Omit Ball Milling Step

Samples of the fine black powder obtained by drying the slurry mixture prepared in examples 15 and 16 were analyzed by XRD and SEM/EDS before ball milling. Analytical data suggested the presence of Si, CuCl₂, and PdCl₂, indicating that ternary silicide did not form. EDS elemental mapping on the sample showed a composition containing Pd₃Cu_{0.5}Si_{50.3}Cl₇, with a stoichiometry corresponding to Pd₁Cu_{0.29}Si_{7.29}Cl_{1.13}.

The intermetallic compounds described herein are useful as catalysts for preparing organofunctional halosilanes. PdSi is useful as a selective catalyst for forming diorganodihalosilanes. The PdSi formed by the method described herein may be used in methods of preparing diorganodihalosilanes such as the methods for preparing diorganodihalosilanes disclosed in WO2011/149588, which is hereby incorporated by reference. Pd₂Si is useful as a selective catalyst for forming organotrihalosilanes. The process described herein may be used to selectively control the stoichiometry of the silicide product produced. Without wishing to be bound by theory, it is thought that formation of PdSi over Pd₂Si may be optimized by controlling the molar ratio of palladium halide and silicon used in step (1) of the method described herein, for example Si:PdX₂ molar ratio may be greater than 2:1, alternatively 2:1 to 1.5:1.

Without wishing to be bound by theory, it is thought that mechanochemical processing in step (2) of the method described above offers the advantage of not requiring extreme temperatures as compared to an electrochemical method or high temperature arc melting process, which may require extreme temperatures. For example, in an arc melting process, the silicon and the metal need to melt while combined in specific ratios. To form PdSi, the mixture is heated above 1400° C. (the melting point of Si is 1410° C.). In an electrochemical method, a molten salt is used to conduct electricity. Most molten salts require temperatures above 600° C.

1. A process comprises:
(1) vacuum impregnating a metal halide on silicon, where the metal halide has formula MX_{q}, where each M is independently a metal atom selected from the group consisting of Ni, Cu, Pd, Pt, Ag, Au, Fe, Co, Rh, Ir, Fe, Ru, Os, Mn, Re, Cr, Mo, W, V, Nb, Ta, Ti, Zr, and Hf; each X is independently a halogen atom, and subscript q has a value matching valence of the metal atom selected for M, thereby producing a mixture comprising M_{z}Si_{w}X_{zq}, where z represents a relative molar amount of the metal atom for M, w represents a relative molar amount of silicon atoms and zq represents a relative molar amount of the halogen atoms in the mixture; and
(2) mechanochemically processing the mixture under an inert atmosphere, thereby producing a redox reaction product comprising
(i) an intermetallic compound of formula M_{z}Si_{(w-y/4)}X_{(zq-y)}, where y represents a molar amount of halogen atom removed from the mixture during step (2), and y<zq; and
(ii) a by-product comprising SiX₄.

2. The process of claim 1, where in step (1), 0<z<1, and a quantity (z+w)=1; and
in step (2), a quantity (z+(w−y/4))<1.

3. The process of claim 1, where the metal halide has formula PdX₂.

4. The process of claim 3, where molar ratio of Si to PdX₂ is at least 1:1, or where molar ratio of Si to PdX₂ is at least 1.5:1.

5. The process of claim 4, where molar ratio of Si to PdX₂ is from 1.5:1 to 10:1.

6. The process of claim 3, where in addition to the metal halide of formula PdX₂, the metal halide further comprises a copper halide selected from the group consisting of CuX, CuX₂, and a combination thereof.

7. The process of claim 1, further comprising step (3): removing all or a portion of the SiX₄.

8. The process of claim 1, further comprising a step of activating the silicon before step (1).

9. (canceled)

10. (canceled)

11. An intermetallic compound of formula CuₙPdₘSi_{(w-y/4)}X_{(zq-y)}; where n represents a molar amount of Cu, m represents a molar amount of Pd, and 0.01 zq<y<0.99 zq.

12. The process of claim 2, where the metal halide has formula PdX₂.

13. The process of claim 4, where in addition to the metal halide of formula PdX₂, the metal halide further comprises a copper halide selected from the group consisting of CuX, CuX₂, and a combination thereof.

14. The process of claim 5, where in addition to the metal halide of formula PdX₂, the metal halide further comprises a copper halide selected from the group consisting of CuX, CuX₂, and a combination thereof.

15. The process of claim 7, further comprising a step of activating the silicon before step (1).

16. The process of claim 3, further comprising step (3): removing all or a portion of the SiX₄.

17. The process of claim 6, further comprising step (3): removing all or a portion of the SiX₄.
